(19) United States
(12) Patent Application Publication
(10) Pub. No.: US 2023/0075334 A1
(43) Pub. Date: Mar. 9, 2023

(54) METHOD FOR DETERMINING, IN PARTS, THE VOLUME OF A BULK MATERIAL FED ONTO A CONVEYOR BELT

(71) Applicant: Rubble Master HMH GmbH, Linz (AT)

(72) Inventors: Christian Hinterdorfer, Gutau (AT); Christian Hinterreiter, Obergrünburg (AT)

(21) Appl. No.: 17/800,031

(22) PCT Filed: May 10, 2021
(86) PCT No.: PCT/AT2021/060162

§ 371 Date: Aug. 16, 2022

(30) Foreign Application Priority Data
May 13, 2020 (AT) A50422/2020

(51) Int. Cl. G06T 7/50; G06T 7/00

(52) U.S. Cl. CPC G06T 7/50; G06T 7/0004; G06T 2207/20084; G06T 2207/20081; G06T 2207/30164

(57) ABSTRACT

A method for determining, in parts, the volume of a bulk material (2) fed onto a conveyor belt (1) captures a depth image (6) of the bulk material (2), in parts, in a capturing region (4) by means of a depth sensor (3). So that bulk material can be reliably classified at conveying speeds of more than 2 m/s even in the case of overlaps without structurally complicated measures, the captured two-dimensional depth image (6) is fed to a convolutional neural network trained in advance, which has at least three convolutional layers lying one behind the other and a downstream volume classifier (20), the output value (21) of which is output as the bulk material volume present in the capturing region (4).

### FIELD OF THE INVENTION

The invention relates to a method for determining, in parts, the volume of a bulk material fed onto a conveyor belt, wherein a depth image of the bulk material is captured, in parts, in a capturing region by means of a depth sensor.

### DESCRIPTION OF THE PRIOR ART

It is known (WO2006027802A1) to measure bulk material on a conveyor belt by means of a dual camera and laser triangulation and to calculate and classify its properties, such as the volume or the geometry of the bulk material, from the measurement data.

A disadvantage of the prior art, however, is that these photogrammetric methods are very time-consuming in determining the volume of the bulk material, since a series of complicated detection and measurement algorithms must be carried out for each grain detected in the bulk material, which require high computing times in total due to the high number of grains and the individual computing effort per grain. Furthermore, in this method, the grains must not overlap on the conveyor belt, which is, however, unavoidable in realistic conveyor operation. Due to these limitations, only about 100-4 200 grains per hour can be measured in the prior art. Since common conveyor belts transport by far more grains than prior art methods can measure in the same period of time, the application of known measuring methods results in a significant slowdown of the conveying speed and thus in productivity losses. Even with sophisticated systems that require a large amount of space, only belt speeds of less than 2 m/s can be achieved in this way.

### OBJECT OF THE INVENTION

The invention is thus based on the object of classifying bulk material reliably at conveying speeds of more than 2 m/s, even in the case of overlaps, without having to take elaborate measures in terms of design.

The invention solves the set object by feeding the captured two-dimensional depth image to a previously trained convolutional neural network, which has at least three convolution layers, and a downstream volume classifier, for example a so-called fully connected layer, whose output value is output as the bulk material volume present in the capturing region. The invention is thus based on the idea that, when two-dimensional depth images are used, the information required for volume determination can be extracted from the depth information after a neural network used for this purpose has been trained with training depth images with a known bulk material volume. The convolution layers reduce the input depth images to a series of individual features, which in turn are evaluated by the downstream volume classifier, so that the total volume of the material mapped in the input depth image can be determined as a result. The number of convolution layers provided, each of which may be followed by a pooling layer for information reduction, may be at least three, preferably five, depending on the available computing power. Between the convolution layers and the downstream volume classifier, a dimension reduction layer, a so-called flattening layer, can be provided in a known manner. The volume therefore no longer has to be calculated for each individual grain. Since in the depth image the distance of the imaged object to the depth sensor is mapped with only one value for each pixel, the amount of data to be processed can be reduced in contrast to the processing of color images, the measurement procedure can be accelerated and the memory requirement necessary for the neural network can be reduced. As a result, the neural network can be implemented on inexpensive Al parallel computing units with GPU support and the method can be used regardless of the color of the bulk material. Also, the bulk material volume can be determined by accelerating the measurement method even at conveyor belt speeds of 3 m/s, preferably 4 m/s. This reduction of the amount of data in the image additionally lowers the error rate for the correct determination of the bulk material volume. In contrast to color or grayscale images, the use of depth images has the additional advantage that the measurement procedure is largely independent of changing exposure conditions. For example, a vgg16 network (Simonyan/Zisserman, Very Deep Convolutional Networks for Large-Scale Image Recognition, 2015), which is usually only used for color images, can be used as a neural network, which is reduced to only one channel, namely for the values of the depth image points. For example, the depth image can be acquired with a 3D camera, since it can be placed above a conveyor belt due to its smaller footprint, even when space is limited. Furthermore, in order to compensate for fluctuations in the detection of the volume and to compensate for erroneous output values of the neural network, several successive output values can be averaged and the average value can be output as the bulk material volume present in the capturing region.

Training the neural network becomes more difficult and the measuring accuracy decreases during operation if elements foreign to the bulk material lie in the capturing region of the depth sensor. These include, for example, vibrating components of the conveyor belt itself, or other machine elements. To avoid the resulting disturbances, it is proposed that the values of those pixels are removed from the depth image and/or the training depth image whose depth corresponds to or exceeds a pre-detected distance between the depth sensor and a background for this pixel. This allows disturbing image information, caused for example by vibrations of the conveyor belt, to be removed and both the depth images and the training images to be limited to the information relevant for the measurement.

The bulk material volume, however, is not sufficient on its own to determine process parameters, as they are required in particular for use in crushers. Therefore, it is proposed that a quantity classifier is placed downstream of the convolution layers for each class of a particle size distribution and that the output values of these quantity classifiers are output as a particle size distribution. This particle size distribution is a histogram that can be formed either with absolute quantity values or with relative quantity values related to the bulk material volume and thus provides important conclusions, for example, about the crushing gap, any disturbances or other process parameters of a crusher. Thus, the measures according to the invention allow the screening curve of crushers with high speeds, which can conventionally only be determined with great effort, to be recorded automatically, since no parameters have to be recorded for individual grains and relevant quantities calculated from them. The determination of the particle size distribution directly from the depth image thus also reduces the susceptibility to errors when determining the particle size distribution.

In order to better classify the bulk material on the basis of its mechanical properties, it is proposed that a cubicity classifier is placed downstream of the convolution layers, the initial value of which is output as cubicity. Cubicity is considered to be the axial ratio of individual grains of the bulk material, which is, for example, the quotient of the length and thickness of the grain.

The training of the neural network requires large quantities of training depth images that represent the bulk material to be detected as accurately as possible. However, the amount of work required to measure the necessary amount of bulk material is extremely high. In order to provide the neural network with sufficient training depth images to determine the bulk material volume, it is proposed that example depth images of an example grain with a known volume are acquired and stored together with the volume, after which several example depth images are randomly combined to form a training depth image, to which the sum of the volumes of the combined example depth images is assigned as bulk material volume, whereupon the training depth image is fed to the neural network on the input side and the assigned bulk material volume is fed to the neural network on the output side and the weights of the individual network nodes are adapted in a learning step. The training method is thus based on the consideration that by combining example depth images of measured example grains, manifold combinations of training depth images can be created. Thus, it is sufficient to acquire example depth images of relatively few example grains with their volume to generate a large number of training depth images with which the neural network can be trained. To train the neural network, the weights between the individual network nodes are adjusted in a known manner in the individual training steps so that the actual output value corresponds as closely as possible to the specified output value at the end of the neural network. Different activation functions can be specified at the network nodes, which are decisive for whether a sum value present at the network node is passed on to the next level of the neural network.

Analogous to the volume, other parameters, such as cubicity, foreign matter or impurity content, or particle size, can also be assigned to the example depth images. Also, for each training depth image, the particle size distribution resulting from the grains of the example depth images can be assigned. For depth image processing, it is also proposed here that the values of those pixels are removed from the depth image whose depth corresponds to or exceeds a pre-detected distance between the depth sensor and the conveyor belt for that pixel. As a result, the training depth images and the depth images of the measured bulk material have only the information relevant for the measurement, which results in a more stable training behavior and increases the recognition rate in the application. By selecting the example depth images or the training depth images composed of them, the neural network can be trained on any type of bulk material.

To further improve the training behavior and recognition rate, it is proposed that the example depth images are assembled with random alignment to form a training depth image. Thus, for a given number of grains per example depth image, the number of possible arrangements of the grains is significantly increased without the need to generate more example depth images and overfitting of the neural network is avoided.

Separation of the grains of the bulk material can be omitted and larger bulk material volumes can be determined at constant conveyor belt speed if the example depth images are combined with partial overlaps to form a training depth image, wherein the depth value of the training depth image in the overlap area corresponds to the smallest depth of both example depth images. In order to capture realistic bulk distributions, the cases where two grains come to rest on top of each other must be considered. The neural network can be trained to detect such overlaps and still determine the volume of the example grains.

### SUMMARY OF THE INVENTION

In the drawing, the subject matter of the invention is shown by way of example, wherein:

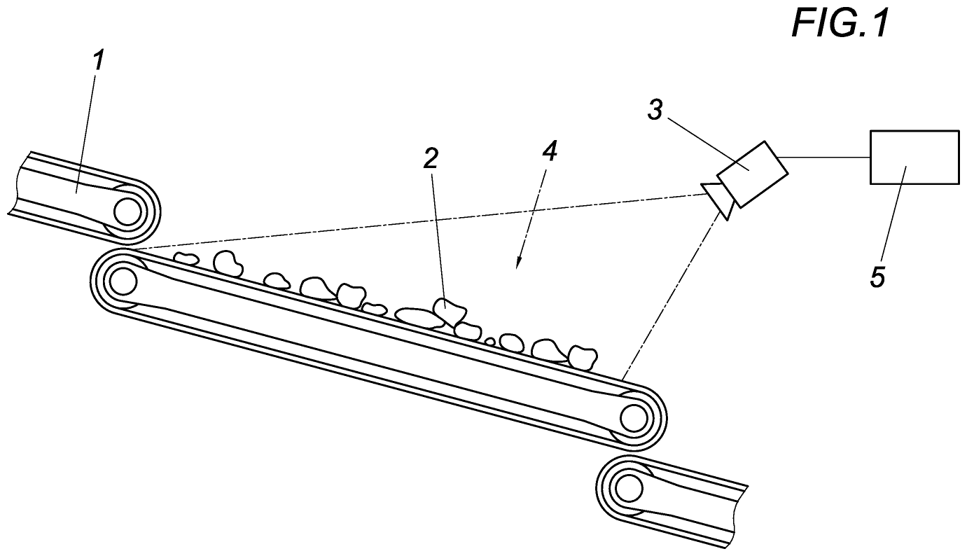

FIG. 1 shows schematic side view of a conveyor belt loaded with bulk material, a depth sensor and a computing unit,

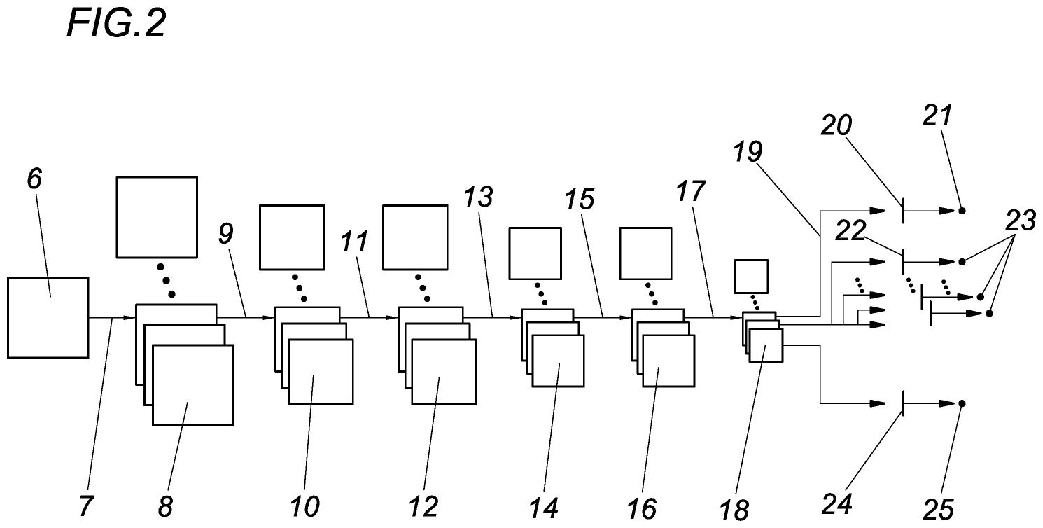

FIG. 2 shows a schematic representation of the convolutional neural network, and

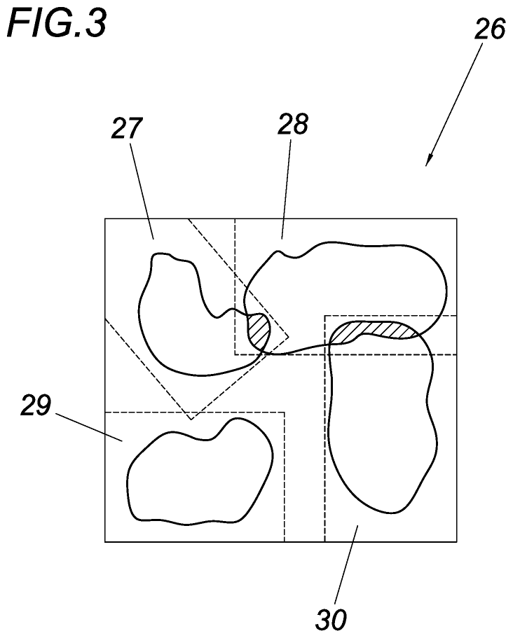

FIG. 3 shows a training depth image composed of four example depth images.

### DETAILED DESCRIPTION OF THE PREFERRED EMBODIMENTS

FIG. 1 shows a device for carrying out the method according to the invention, which comprises a conveyor belt 1 on which bulk material 2 has been fed. A depth sensor 3 creates depth images 6 of the bulk material 2 in a capturing region 4 of the depth sensor 3 and sends them to a computing unit 5.

In the computing unit 5, the depth images are fed to a neural network and processed by it. The determination of the bulk material volume can include the following steps as an example and is shown for a depth image 6 in FIG. 2: In a first step 7, the depth image 6 is fed to the first convolution layer. In this process, several outputs 8, so-called feature maps, which depict different aspects, are generated in the convolution layer from the depth image 6 by pixel-wise convolution of the depth image 6 with a convolution kernel. These outputs 8 have the same dimensions and the same number of pixels as the depth image 6. In the next step 9, the number of pixels is reduced by means of a pooling layer. In this process, for each output 8, only the one with the highest value is selected from a square of, for example, 4 pixels and transferred to a corresponding pixel of the output 10, which is now compressed compared to the output 8. Since these squares overlap, this reduces the number of pixels by a factor of 2. Steps 7 and 9 are now repeated in additional layers, but in step 11 the convolution is applied to each output 10, further increasing the number of outputs 12 generated. Applying the pooling layer to the outputs 12 in step 13 further lowers the pixel count and produces outputs 14. Step 15 is analogous to step 11 and produces outputs 16. Step 17 is analogous to step 13, lowering the pixel count and producing output 18. The application steps of the convolution and pooling layers can be repeated further depending on the aspects to be determined in depth image 6. In step 19, the pixels of output 18 are aligned by dimensional reduction, and their information is transmitted to a classifier, such as a volume classifier 20, whose output value 21 may be output as the bulk material volume present in the capturing region. In addition to the volume classifier 20, additional quantity classifiers 22 may be provided whose output values 23 form the relative or absolute quantities of the histogram of a particle size distribution. Furthermore, a cubicity classifier 24 can also be provided, the output value 25 of which corresponds to the average cubicity of the bulk material 2 present in the capturing region.

The structure of a training depth image 26 can be seen in FIG. 3. Here, four example depth images 27, 28, 29, 30 of different grains measured in advance are combined to form a training depth image 25. The example depth images 27, 28, 29, 30 can be combined in any positioning and orientation to form a training depth image 26 and partially overlap. The overlaps are shown hatched in the training depth image 26.

1. A method for determining, in parts, the volume of a bulk material fed onto a conveyor belt, said method comprising:
capturing a depth image of the bulk material in parts in a capturing region with a depth sensor; and
feeding the captured two-dimensional depth image to a pre-trained convolutional neural network that has at least three successive convolution layers and a downstream volume classifier; and
outputting an output value of the pre-trained convolutional neural network as the volume of the bulk material present in the capturing region.

2. The method according to claim 1, wherein the depth image comprises pixels each having a respective value having a depth, and the method further comprises removing from the depth image the values of the pixels the depth of which corresponds to, or exceeds, a previously detected distance between the depth sensor and a background for the pixel.

3. The method according to claim 1, wherein a quantity classifier is arranged downstream of the convolution layers for each class of a particle size distribution, and the method further comprises outputting output values of said quantity classifiers as a particle size distribution.

4. The method according to claim 1, wherein a cubicity classifier is arranged downstream of the convolution layers, the method further comprises outputting an output value thereof as cubicity.

5. A training method for training a neural network for the method according to claim 1, said training method comprising:
first acquiring example depth images each of a respective example grain with a respective known volume and storing each of said example depth images together with the respective known volume;
combining a plurality of said example depth images randomly sa as to form a training depth image, to which a sum of the known volumes of the combined example depth images is assigned as an assigned bulk material volume;
feeding the training depth image to the neural network on an input side and feeding the assigned bulk material volume to the neural network on an output side; and
adapting weights of individual network nodes of the neural network in a learning step.

6. The training method according to claim 5, wherein the training depth image is formed by assembling the example depth images with random alignment.

7. The training method according to claim 5, wherein two of the example depth images are combined with partial overlaps in an overlap region so as to form the training depth image, and wherein the training depth image in the overlap region has a depth value that corresponds to a lowest depth of both of the combined example depth images.

8. The training method according to claim 6, wherein two of the example depth images are combined with partial overlaps in an overlap region so as to form the training depth image, and wherein the training depth image in the overlap region has a depth value that corresponds to a lowest depth of both of the combined example depth images.

9. The method according to claim 2, wherein a quantity classifier is arranged downstream of the convolution layers for each class of a particle size distribution, and the method further comprises outputting output values of said quantity classifiers as a particle size distribution.

10. The method according to claim 2, wherein a cubicity classifier is arranged downstream of the convolution layers, the method further comprises outputting an output value thereof as cubicity.

11. The method according to claim 3, wherein a cubicity classifier is arranged downstream of the convolution layers, the method further comprises outputting an output value thereof as cubicity.
